(19) United States
(12) Patent Application Publication
(10) Pub. No.: US 2019/0214936 A1
(43) Pub. Date: Jul. 11, 2019

(54) SOLAR PANEL AND PORTABLE POWER BANK

(71) Applicant: Sunflare Co., Chino, CA (US)

(72) Inventor: Paul Vela, Pasadena, CA (US)

(21) Appl. No.: 16/242,433

(22) Filed: Jan. 8, 2019

Related U.S. Application Data
(60) Provisional application No. 62/615,182, filed on Jan. 9, 2018.

(51) Int. Cl. H02S 10/40; H02J 7/35; H02J 7/00

(52) U.S. Cl. CPC H02S 10/40; H02J 7/0027; H02J 7/355

(57) ABSTRACT

An apparatus includes a solar panel with an attachment mechanism and one or more photovoltaic cells that are configured to generate electrical energy. The attachment mechanism includes a connection element and an attachment mechanism electrical contact that is configured to output the electrical energy generated by the one or more photovoltaic cells. The apparatus also includes a portable power bank that is configured to removably connect to the solar panel. The portable power bank includes a portable power bank electrical contact configured to contact the attachment mechanism electrical contact and receive the electrical energy output by the attachment mechanism electrical contact when the portable power bank is connected to the solar panel. The portable power bank also includes a connection member configured to engage the connection element of the attachment mechanism in an engagement position and disengage the connection element of the attachment mechanism in a disengagement position.

### RELATED APPLICATION

This application claims the benefit of U.S. Provisional Application No. 62/615,182 filed Jan. 9, 2018, the contents of which are hereby incorporated by reference.

### TECHNICAL FIELD

This disclosure generally describes devices, apparatuses, and methods relating to a portable power bank and/or solar panel(s). More particularly, this disclosure relates to coupling a portable power bank to a solar panel so that the portable power bank, either while coupled to the solar panel or while removed from the solar panel, can be used to power another device via electrical outputs on the portable power bank. For instance, while coupled to the solar panel, the portable power bank may be electrically charged with the electrical energy generated by the solar panel.

### BACKGROUND

Solar panels are used to convert sunlight into electrical energy. Traditional solar panels are generally large in size, being relatively bulky, or thick. These traditional solar panels are usually anchored in place at a support structure that is fixed at a location that is generally difficult to access (e.g., a roof). When installed, wiring is interconnected between each of these traditional solar panels. However, the size and/or installation of such traditional solar panels can limit the number of applications in which these traditional solar panels can be used.

### SUMMARY

In general, various exemplary embodiments relating to a portable power bank are disclosed herein. More particularly, various exemplary embodiments relating to removably, electrically connecting a portable power bank to another device, such as a solar panel and/or an accessory, are disclosed herein. For instance, the portable power bank can be secured to one or more other devices and receive electrical power from this device, for instance a solar panel, and/or provide electrical power to this device, for instance an accessory device. Features disclosed herein may be useful in providing user-friendly, quick electrical coupling and release functionality for charging a portable power bank in an eco-friendly manner as well providing electrical power from a portable power bank to another device in an eco-friendly manner. Features disclosed herein may be useful in increasing the number of applications in which electrical energy generated by a solar panel can be used.

One exemplary embodiment includes a portable power bank and solar panel apparatus. This apparatus embodiment has a solar panel and a portable power bank. The solar panel has one or more photovoltaic cells that are configured to generate electrical energy and an attachment mechanism. The attachment mechanism includes a connection element and an attachment mechanism electrical contact that is configured to output the electrical energy generated by the one or more photovoltaic cells. The portable power bank is configured to removably connect to the solar panel. The portable power bank includes a portable power bank electrical contact configured to contact the attachment mechanism electrical contact and receive the electrical energy output by the attachment mechanism electrical contact when the portable power bank is connected to the solar panel. The portable power bank also includes a connection member having an engagement position and a disengagement position. The connection member is configured to engage the connection element of the attachment mechanism when in the engagement position and disengage the connection element of the attachment mechanism when in the disengagement position. When the connection member engages the connection element the portable power bank is secured in place at the solar panel and when the connection member disengages the connection element the portable power bank is removable from the solar panel.

Another exemplary embodiment includes a portable power bank. This portable power bank embodiment has an attachment receptacle, a portable power bank electrical contact, and a connection member. The attachment receptacle is configured to receive an attachment mechanism. The portable power bank electrical contact is configured to contact an attachment mechanism electrical contact to establish an electrical connection between the portable power bank and the attachment mechanism. The connection member is located at the attachment receptacle and has an engagement position and a disengagement position. The connection member is configured to engage a connection element of the attachment mechanism when in the engagement position and disengage the connection element of the attachment mechanism when in the disengagement position. When the connection member engages the connection element the portable power bank is secured in place at the attachment mechanism and when the connection member disengages the connection element the portable power bank is removable from the attachment mechanism.

### BRIEF DESCRIPTION OF DRAWINGS

The following drawings are illustrative of particular examples of the present invention and therefore do not limit the scope of the invention. The drawings are not necessarily to scale and are intended for use in conjunction with the explanations in the following detailed description where like numerals refer to like features. Examples of the present invention will hereinafter be described in conjunction with the appended drawings.

FIG. 1 is a perspective view of an exemplary embodiment of a portable power bank and solar panel apparatus.

FIG. 2 is a close up perspective view of a portion of the portable power bank and solar panel apparatus of FIG. 1 with the portable power bank removed from the solar panel.

FIG. 3 is the close up perspective view of the portion of the portable power bank and solar panel apparatus of FIG. 2 showing a cross-section of the portable power bank taken along line A-A in FIG. 2.

FIG. 4 is the close up perspective view of the portion of the portable power bank and solar panel apparatus of FIG. 2 showing a cross-section of the portable power bank taken along line B-B in FIG. 2.

FIG. 5 is a side elevational view of the portable power bank component of the portable power bank and solar panel apparatus of FIG. 1.

FIG. 6 is a perspective view of an exemplary embodiment of an accessory that has an attachment mechanism for connection to the portable power bank of FIG. 1.

### DETAILED DESCRIPTION

The details of one or more examples are set forth in the accompanying drawings and the description below where like numerals refer to like features. Other features, objects, and advantages will be apparent from the description and drawings, and from the listing of exemplary embodiments. The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

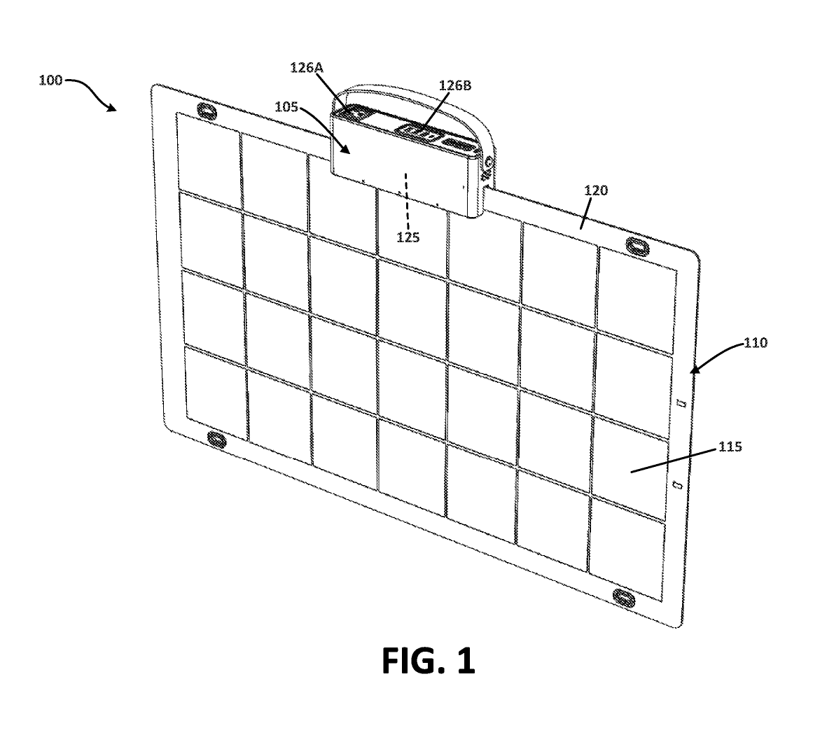

FIG. 1 illustrates an exemplary embodiment of a portable power bank and solar panel apparatus 100. The apparatus 100, as shown here, includes a portable power bank 105 and a solar panel 110. In general, the apparatus 100 can include a removable, electrical connection between the portable power bank 105 and the solar panel 110 and via this connection can be configured to supply (e.g., charge) the portable power bank 105 with electrical energy generated by the solar panel 110. The portable power bank 105 can be removed from the solar panel 110 and used to power any number of a variety of electrical load devices via one or more electrical outlets on the portable power bank 105. Although removing the portable power bank 105 from the solar panel 110 may often be most convenient for powering other electrical load devices, in some instances the portable power bank 105 could be used to power any number of a variety of electrical load devices while the portable power bank 105 is connected to the solar panel 110. In this instance, the portable power bank 105 can serve as an output for electrical energy generated by the solar panel 110.

The solar panel 110 can include one or more photovoltaic cells 115 and an edge surface 120. In the illustrated embodiment, the edge surface 120 forms a perimeter of the solar panel 110 and bounds the photovoltaic cells 115. Though, in other embodiments, the edge surface 120 may form only one or more portions of the perimeter of the solar panel 110. As also shown in the illustrated embodiment, the edge surface 120 may not include any photovoltaic cell 115. Each photovoltaic cell 115 can convert sunlight into electrical energy. The solar panel 110 can include internal conductive lines running from the photovoltaic cells 115 to an electrical outlet 125 at the edge surface 120. The portable power bank 105 can be removably, electrically connected to solar panel 110 at the electrical outlet 125 to receive, and in many cases store, electrical energy generated by the solar panel 110.

As noted, the portable power bank 105 can be configured to power any number of a variety of electrical load devices with electrical energy generated by the solar panel 110, either while connected to the solar panel 110 or when removed from the solar panel 110. As shown in the exemplary embodiment in FIG. 1, the portable power bank 105 can include one or more electrical outlet ports 126A, 126B. Each of the one or more electrical outlet ports 126A, 126B on the portable power bank 105 can be configured to electrically connect the portable power bank 105 to an electrical load device and provide electrical power to such connected electrical load device.

For example, the portable power bank 105 can include two or more electrical outlet ports 126A, 126B that are of a different configuration so as to be adapted to electrically connect to different types of electrical connectors of electrical load devices. In the illustrated embodiment, the electrical outlet port 126A is a 110 volt or 120 volt outlet port configured to receive a corresponding plug (e.g., two prongs, three prongs) of an electrical load device. In the illustrated embodiment, the electrical outlet port 126B includes a number of universal serial bus (“USB”) outlet ports each configured to receive a corresponding USB cable plug of an electrical load device. Accordingly, the portable power bank 105 can receive electrical energy generated by the solar panel 110 and provide this electrical energy to an electrical load device via the electrical outlet port 126A or 126B. For instance, when the portable power bank 105 is connected to the solar panel 110 the portable power bank 105 can receive and store electrical energy generated by the solar panel 110 and then be removed from the solar panel 110 and used to conveniently provide a power source for one or more electrical load devices. Electrical load devices that can receive electrical power from the portable power bank 105 can be any type of electrically powered device. The presence of different types of electrical outlet ports 126A, 126B may be useful for increasing the types of electrical load devices that can receive power from the portable power bank 105.

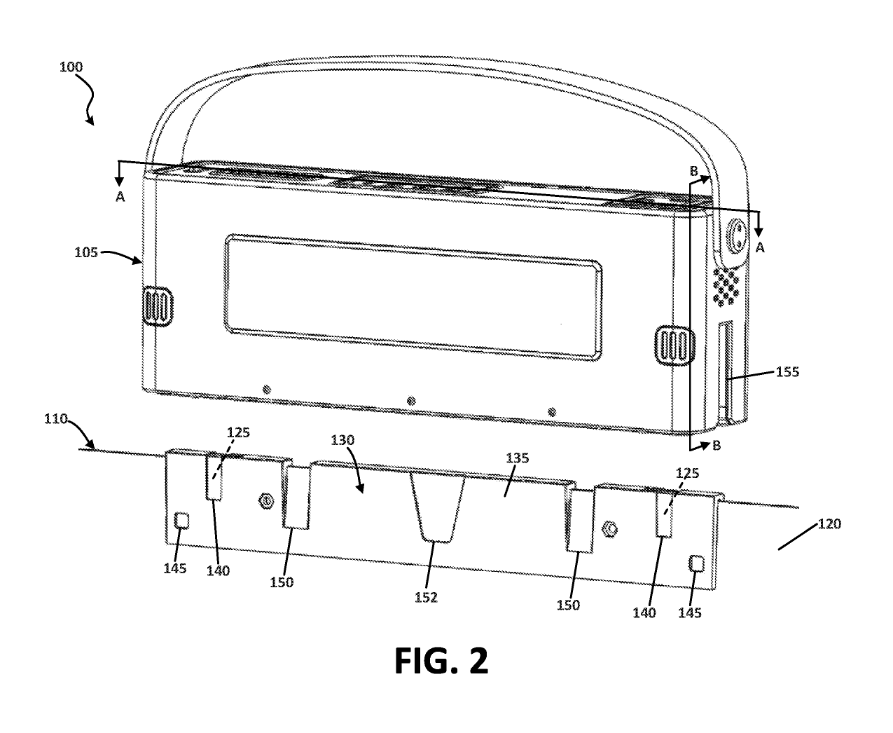

FIG. 2 illustrates a close up perspective view of a portion of the portable power bank and solar panel apparatus 100 of FIG. 1. As noted previously, the portable power bank 105 can be removably, electrically connected to solar panel 110 at the electrical outlet 125 of the solar panel 110. In FIG. 2, the portable power bank 105 is removed from the solar panel 110. Features disclosed herein may be useful in providing user-friendly, quick connection and release functionality for charging the portable power bank 105 in an eco-friendly manner. For instance, when the portable power bank 105 is electrically connected to the solar panel 110, as shown in the example of FIG. 1, the portable power bank 105 can receive and store electrical energy generated by the solar panel 110. The portable power bank 105 can be removed from the solar panel 110, as shown in the example of FIG. 2, and transported as desired to provide electrical power to any number of a variety of electrical load devices.

To removably, electrically connect the portable power bank 105 to the solar panel 110, the solar panel 110 can include an attachment mechanism 130. The attachment mechanism 130 can be configured to removably connect to the portable power bank 105 and electrically connect the portable power bank 105 to the solar panel 110.

The attachment mechanism 130 can include an attachment body 135. In the illustrated embodiment, the attachment body 135 is located at the edge surface 120 of the solar panel 110. The attachment body 135 can be fixed (e.g., molded, adhered, etc.) in place at the solar panel 110 at the electrical outlet 125 on the edge surface 120. In the example here, the attachment body 135 has a generally “U” shaped cross-sectional configuration and straddles the edge surface 120 extending from a first side of the edge surface 120, over an end of the edge surface 120, to a second, opposite side of the edge surface 120 on the second, opposite side of the solar panel 110. In various embodiments, the attachment mechanism 130 can have many of the same features shown at the first side of the attachment body 135 in FIG. 2 at the second, opposite side of the attachment body 135 not seen in FIG. 2.

The attachment body 135 of the attachment mechanism 130 can include one or more electrical contacts 140. The illustrated embodiment of the attachment mechanism 130 includes two electrical contacts 140. The electrical contacts 140 can be made of a different, more conductive material than that from which the attachment body 135 is made. In the illustrated embodiment, the attachment body 135 includes two electrical contacts 140 that are spaced apart along a longitudinal axis of the attachment body 135. The electrical contacts 140 can be electrically connected to the electrical outlet 125 of the solar panel 110. For instance, the electrical contacts 140 can be connected to one or more internal conductive lines running from the photovoltaic cells of the solar panel 110 such that the electrical contacts 140 are configured to output electrical energy generated by the solar panel 110. The electrical contacts 140 can run along one or more surfaces of the attachment body 135. In the illustrated embodiment, the electrical contacts 140 run along a first outer surface (e.g., a surface of the attachment body 135 opposite that interfacing with the first side of the edge surface 120) of the attachment body 135, over an end (e.g., a surface of the attachment body 135 opposite that interfacing with the end of the edge surface 120) of the attachment body 135, to a second, opposite outer surface (e.g., a surface of the attachment body 135 opposite that interfacing with the second side of the edge surface 120) of the attachment body 135. In such an example, each of the electrical contacts 140 is present at both the first side of the attachment mechanism 130, shown in FIG. 2, as well as the second, opposite side of the attachment mechanism 130. Accordingly, here the electrical contacts 140 have a generally “U” shaped cross-sectional configuration similar to that of the attachment body 135.

The attachment body 135 of the attachment mechanism 130 can also include one or more connection elements 145. In the illustrated embodiment, the attachment body 135 includes two connection elements 145 shown in FIG. 2 generally aligned on the first outer surface of the attachment body 135 and spaced apart along the longitudinal axis of the attachment body 135. In a further embodiment, the attachment body 135 can include two additional connection elements, not seen in FIG. 2, generally aligned on the second, opposite outer surface of the attachment body 135, and spaced apart along the longitudinal axis of the attachment body 135. When such additional connection elements 145 are included, they can have the same structure as shown in FIG. 2 on the opposite side of the attachment body 135. Each connection elements 145 can be configured to receive, and attach to, a corresponding connection member on the portable power bank 105 to removably, mechanically connect the portable power bank 105 to the solar panel 110.

In the illustrated example, the connection elements 145 of the attachment mechanism 130 are in the form of recessed apertures formed in the outer surface of the attachment body 135 that are configured to receive corresponding connection members on the portable power bank 105 and thereby form an interference fit between the respective connection elements 145 and corresponding connection members on the portable power bank 105. For instance, the corresponding connection members on the portable power bank 105 can be extensions configured to be received within the recessed connection elements 145 of the attachment mechanism 130. As shown here, the illustrated, exemplary connection elements 145 form recessed apertures in the outer surface of the attachment body 135 at a location that is spaced from the perimeter of the attachment body 135.

The attachment body 135 of the attachment mechanism 130 may further include one or more guide channels 150. In the illustrated embodiment, the attachment body 135 includes two guide channels 150 that each run along the first outer surface of the attachment body 135, over an end of the attachment body 135, to a second, opposite outer surface of the attachment body 135. The guide channels 150 can be spaced apart along the longitudinal axis of the attachment body 135. Each of the guide channels 150 can be configured to receive a corresponding channel fitment structure on the portable power bank 105. The guide channels 150 can serve to appropriately align the portable power bank 105 when the portable power bank 105 is being connected at the attachment mechanism 130. For example, the guide channels 150 can help to ensure that the electrical contacts 140 and connection elements 145 on the attachment mechanism 130 are appropriately aligned with the corresponding features (e.g., electrical contacts and connection members) of the portable power bank 105 so that a suitable connection is made between the portable power bank 105 and the solar panel 110.

In the illustrated embodiment, each of the guide channels 150 is in the form of a recess in the attachment body 135 that begins at the end surface of the attachment body 135 and extends a distance in a direction inward toward the solar panel 110. In one such example, as shown here, the guide channels 150 in the form of a recess can include a varying recess depth into the attachment body 135 along a length of the guide channels 150. For instance, as shown here, the recess depth of the guide channels 150 can decrease at a generally uniform slope as the guide channels 150 extend from the end surface of the attachment body 135 inward in a direction toward the solar panel 110. The guide channels 150 can have the same structure as shown in FIG. 2 on the opposite side of the attachment body 135.

In some embodiments, the attachment body 135 of the attachment mechanism 130 may additionally include an orientation groove 152. While certain other features of the attachment mechanism 130, such as the electrical contacts 140 and the guide channels 150, may be present on both sides of the attachment body 135, the orientation groove 152 may be present on only one side of the attachment body 135 (e.g., the side of the attachment body 135 seen in FIG. 2). The orientation groove 152 can be configured to receive a corresponding orientation fitment structure on the portable power bank 105. Just as the orientation groove 152 can be present on only one side of the attachment body 135, the corresponding orientation fitment structure on the portable power bank 105 can be present on only one, corresponding side of the portable power bank 105. As such, the orientation groove 152 can serve to ensure that the portable power bank 105 is being connected at the attachment mechanism 130 in a proper orientation. For example, the orientation groove 152 can help to ensure that the correct side of the portable power bank 105 is interfacing with the corresponding correct side of the attachment mechanism 130 while the portable power bank 105 is being connected to the solar panel 110. This can be useful in embodiments where features configured to connect the portable power bank 105 and attachment mechanism 130 are located on only one side of the portable power bank 105 and attachment mechanism 130 since the orientation groove 152 can help to ensure that the correct side of the portable power bank 105 is interfacing with the corresponding correct side of the attachment mechanism 130.

In the illustrated example, the orientation groove 152 can take the form of a recess in the attachment body 135. In one embodiment, the orientation groove 152 can include a varying recess depth into the attachment body 135 along a length of the orientation groove 152. For instance, as shown here, the recess depth of the orientation groove 152 can decrease at a generally uniform slope as the orientation groove 152 extends from the end surface of the attachment body 135 inward in a direction toward the solar panel 110. In the illustrated embodiment, the orientation groove 152 has a width that reduces as the orientation groove 152 extends from the end surface of the attachment body 135 inward in a direction toward the solar panel 110.

In order to removably connect to the solar panel 110, the portable power bank 105 can include an attachment receptacle 155. The attachment receptacle 155 can be configured to removably, electrically connect to the attachment mechanism 130 at the solar panel 110. In the illustrated embodiment, the attachment receptacle 155 can be configured to receive at least a portion of the attachment body 135. As the attachment receptacle 155 is placed onto the attachment body 135, features of the attachment body 135 can be aligned, and ultimately be positioned to interface, with corresponding features of the attachment receptacle 155 to removably, electrically connect the portable power bank 105 to the solar panel 110.

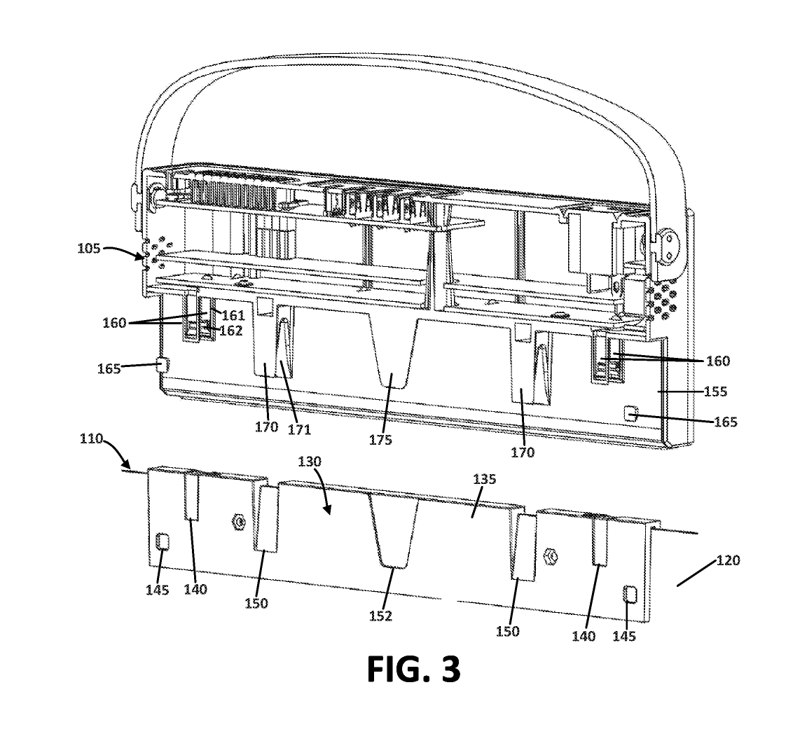

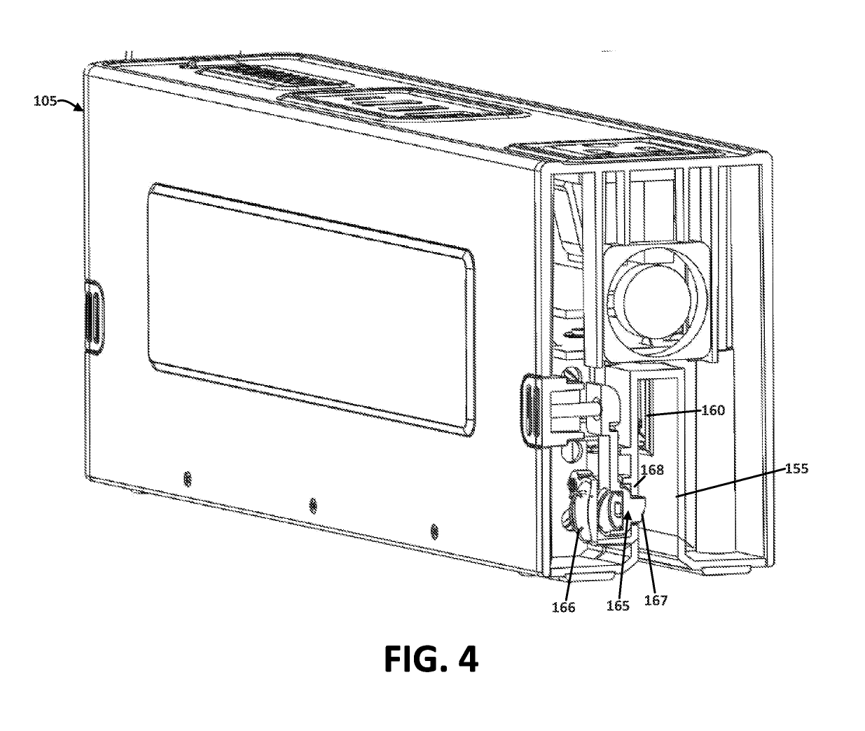

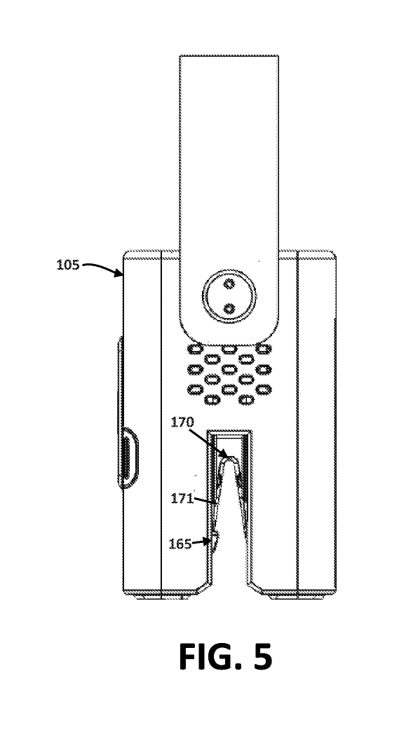

FIGS. 3-5 illustrate exemplary features of the attachment receptacle 155 of the portable power bank 105 that can be configured to removably, electrically connect the portable power bank 105 to the attachment mechanism 130 at the solar panel 110. FIG. 3 shows the close up perspective view of the portion of the portable power bank and solar panel apparatus of FIG. 2, including a cross-sectional view of the portable power bank 105 taken along line A-A in FIG. 2. FIG. 4 shows the close up perspective view of the portion of the portable power bank and solar panel apparatus of FIG. 2, including a cross-sectional view of the portable power bank 105 taken along line B-B in FIG. 2. FIG. 5 shows a side elevational view of the portable power bank 105.

The portable power bank 105 can include one or more features at the attachment receptacle 155 that are configured to removably, electrically connect to the attachment mechanism 130. In the illustrated embodiment, at the attachment receptacle 155 of the portable power bank 105 includes electrical contacts 160, connection members 165, channel fitment structures 170, and orientation fitment structure 175. In embodiments where the attachment mechanism 130 includes electrical contacts 140 and guide channels 150 on both sides of the attachment body 135, such as that illustrated here, corresponding electrical contacts 160 and channel fitment structures 170 can be present on both sides of the attachment receptacle 155. Likewise, in embodiments where the attachment mechanism 130 includes connection elements 145 and orientation groove 152 on one side of the attachment body 135, such as that illustrated here, corresponding connection members 165 and orientation fitment structure 175 can be present on only the corresponding side of the attachment receptacle 155.

At least a portion of each of the electrical contacts 160 at the attachment receptacle 155 of the portable power bank 105 can be configured to directly contact the corresponding electrical contacts 140 on the attachment body 135 when the attachment receptacle 155 is received at the attachment body 135. Each of the electrical contacts 160 at the attachment receptacle 155 can include a conductive portion that interfaces with, and directly contacts, a conductive portion of the corresponding electrical contact 140 on the attachment body 135. In the illustrated example, the portable power bank 105 includes four electrical contacts 160, Here, one pair of electrical contacts 160 is aligned on opposite sides of the attachment receptacle 155 and spaced a longitudinal distance from another pair of electrical contacts 160 that are aligned on opposite sides of the attachment receptacle 155. As shown in the illustrated embodiment, each of the electrical contacts 160 can include a flange 161 and a contact protrusion 162. The contact protrusion can be positioned on the flange 161 and extend out from a surface of the flange 161 that faces the attachment receptacle 155.

When the attachment receptacle 155 is received at the attachment body 135, the electrical contacts 140, 160 are brought in to contact and the electrical contacts 140 can transmit electrical energy to the electrical contacts 160. The electrical contacts 160 can be electrically connected to a battery and/or electrical outlet port of the portable power bank 105 and thereby supply electrical power from the solar panel 110 to the battery and/or electrical outlet port of the portable power bank 105.

Each connection member 165 at the attachment receptacle 155 of the portable power bank 105 can be configured to engage, and secure to, a respective connection element 145 on the attachment body 135 when the attachment receptacle 155 is received at the attachment body 135. By being configured to secure to a respective connection element 145 on the attachment body 135, each connection member 165 can removably, mechanically connect the portable power bank 105 to the solar panel 110.

As one example, the connection members 165 can be biased extensions configured to be received within the respective connection elements 145 on the attachment body 135. In such an example, each connection member 165 can include a biasing member 166 that biases an extension face 167 of the connection member 165 to an engagement position (e.g., shown in FIGS. 4 and 5) within the attachment receptacle 155. In this example, when the connection member 165 is in the engagement position, the extension face 167 can extend out into the attachment receptacle. When the attachment receptacle 155 is initially paced onto the attachment body 135, the interfacing surface of the attachment body 135 can overcome the bias provided by the biasing member 166 and push the extension face 167 to a disengagement position. In this example, when the connection member 165 is in the disengagement position, the extension face 167 can be retracted within a wall 168 of the attachment receptacle 155 and inward from its engagement position within the attachment receptacle 155. Then, as the attachment receptacle is further received at the attachment body 135, each connection member 165 will align with the corresponding connection element 145 causing the biasing member 166 to bring the connection member back to its engagement position such that the extension face 167 is again brought to extended out from the wall 168 and into the corresponding recess of the connection element 145. Engagement of the extension face 167 at the corresponding connection element 145 can mechanically secure the portable power bank 105 to the attachment mechanism 130 and thus secure the portable power bank 105 in place at the solar panel 110.

In one example, the portable power bank 105 could include a button, or similar actuation mechanism, to selectively overcome the bias on each connection member 165 while the attachment receptacle 155 is being received at the attachment mechanism 130. Thus, by actuating the button the extension face 167 can be retracted from its engagement position within the attachment receptacle 155 and brought within the wall 168 to the disengagement position. Likewise, when the button is released, the biasing member 166 can urge the extension face back to the engagement position to thereby engage the corresponding connection element 145 and thereby removably couple the portable power bank 105 to the solar panel 110.

Each of the channel fitment structures 170 at the attachment receptacle 155 of the portable power bank 105 can be configured to be received at the corresponding guide channel 150 on the attachment body 135 when the attachment receptacle 155 is received at the attachment body 135. In the illustrated embodiment, there are two channel fitment structures 170 spaced a longitudinal distance apart along the attachment receptacle 155.

Each channel fitment structure 170 can include an interior surface 171. The interior surface 171 can extend from one side of the attachment receptacle 155 to another, opposite side of the attachment receptacle 155. In the illustrated embodiment, the interior surface 171 of the channel fitment structure 170 defines an arch, or “U” cross-sectional shape. This interior surface 171 can interface with, and directly contact, the corresponding guide channel 150. For example, here the interior surface 171 can interface with, and directly contact, the corresponding guide channel 150 at the first side of the attachment body 135, at the end surface of the attachment body 135, and at the second, opposite side of the attachment body 135 and thus straddle the corresponding guide channel 150. The interior surface 171 can be angled to match the varying depth of the recess formed by the corresponding guide channel 150. For instance, here, the interior surface 171 can increase in diameter moving in a direction from the top of the arch, or “U cross-section shape, toward the open end of the attachment receptacle 155. In this way, the corresponding guide channels 150 and channel fitment structures 170 can serve to appropriately align the portable power bank 105 when it is being connected at the attachment mechanism 130 by helping to ensure that the electrical contacts 140 and connection elements 145 on the attachment mechanism 130 are appropriately aligned with the corresponding electrical contacts 160 and connection members 165 of the portable power bank 105.

When an orientation groove 152 is included at the attachment body 135, the portable power bank 105 can include a corresponding orientation fitment structure 175. The orientation fitment structure 175 at the attachment receptacle 155 of the portable power bank 105 can be configured to be received at the corresponding orientation groove 152 on the attachment body 135 when the attachment receptacle 155 is received at the attachment body 135. In the illustrated embodiment, the orientation groove 152 is included on only one side of the attachment body 135 and the corresponding orientation fitment structure 175 is likewise included on only the corresponding side of the attachment receptacle 155. As such, the corresponding orientation groove 152 and orientation fitment structure 175 can serve to help ensure that the portable power bank 105 is being connected at the attachment mechanism 130 in a proper orientation (e.g., such that the correct side of the portable power bank 105 is interfacing with the corresponding correct side of the attachment mechanism 130 while the portable power bank 105 is being connected to the solar panel 110). Thus, the attachment receptacle 155 may be unable to receive the attachment mechanism 130 when the portable power bank 105 is oriented relative to the attachment mechanism 130 such that the side of the attachment mechanism 130 having the connection elements 145 does not interface with the side of the attachment receptacle 155 having the connection members 165.

When the attachment receptacle 155 is received at the attachment body 135, an interior surface of the orientation fitment structure 175 can interface with, and directly contact, the orientation groove 152. The orientation fitment structure 175 can have a varying thickness along its length such that the interior surface of the orientation fitment structure 175 extends into the attachment receptacle at a varying degree. The varying thickness of the orientation fitment structure 175 can correspond to the varying recess depth of into the attachment body 135 along a length of the orientation groove 152. Also, the orientation fitment structure 175 can have a width that reduces in a manner corresponding to a width reduction of the orientation groove 152 (e.g., a width that reduces as the orientation fitment structure 175 extends in a direction toward the open end of the attachment receptacle 155).

One or more of the features disclosed herein for facilitating the removable, electrical connection between the portable power bank 105 and the solar panel 110 can provide quick connection and release functionality in a user-friendly, reliable manner for charging the portable power bank 105 in an eco-friendly manner. These features can help to increase the number, and type of, applications in which solar power can be used since these features can make solar power easier to access and use. For instance, in addition to the electrical outlet ports on the portable power bank 105, certain accessories may include the attachment mechanism 130. This can allow such accessories to be removably, electrically, connected to the portable power bank 105 at the attachment receptacle 155, just as the solar panel 110 is connected to the portable power bank 105.

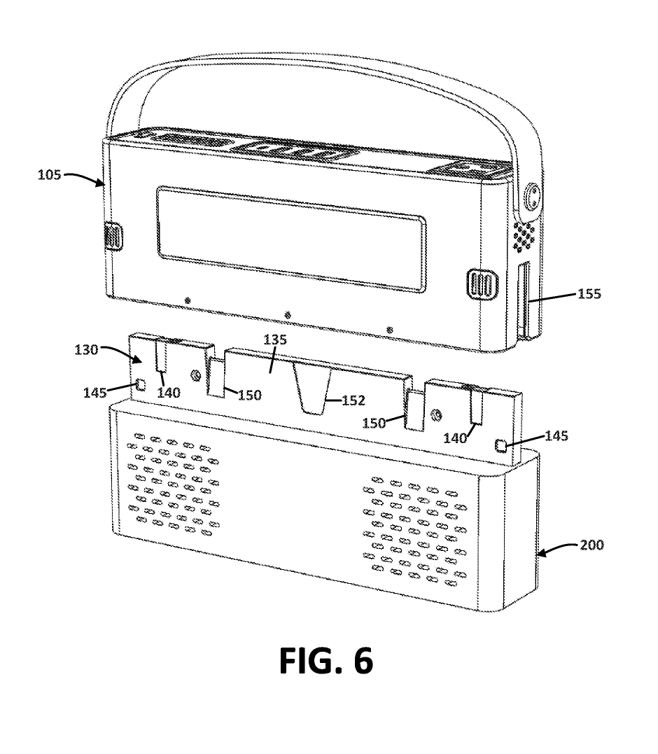

FIG. 6 shows a perspective view of an exemplary embodiment of an accessory 200 that has the attachment mechanism 130 for connection to the portable power bank 105. The attachment mechanism 130 on the accessory 200 can be the same as that described elsewhere herein. Accordingly, the accessory 200 can be removably, electrically connected to the portable power bank 105 when the attachment mechanism 130 is received at the attachment receptacle 155. When the accessory 200 and portable power bank 105 are electrically connected as such, the accessory 200 can draw electrical power from the portable power bank 105 via the electrical contacts 140. Thus, the portable power bank 105 can be electrically connected to the solar panel as described previously and receive and store, at an internal battery, electrical power generated by the solar panel. This stored electrical power can then be used to power the accessory 200 when the accessory 200 is connected to the portable power bank 105.

The accessory 200 can be any type of electrically powered device. In the illustrated exemplary embodiment, the accessory 200 is a speaker. However, the attachment mechanism can be included on any type of electrically powered device so that such electrically powered device can be powered by the portable power bank 105. Alternatively, as described previously herein, an accessory can plug into an electrical outlet port on the portable power bank 105 and receive electrical power from the portable power bank 105 in this manner.

Embodiments also within the scope of the present disclosure include various methods. For example, one embodiment can include a method of transferring electrical power from a solar panel to a portable power bank where this method incorporates features described previously herein, such as features relating to the attachment mechanism and/or attachment receptacle. Another embodiment can include a method of powering an accessory using a portable power bank where this method incorporates features described previously herein, such as features relating to the attachment mechanism, and/or attachment receptacle.

Various examples have been described with reference to certain disclosed embodiments. The embodiments are presented for purposes of illustration and not limitation. One skilled in the art will appreciate that various changes, adaptations, and modifications can be made without departing from the scope of the invention.

What is claimed is:

1. A portable power bank and solar panel apparatus comprising:
a solar panel comprising:
one or more photovoltaic cells configured to generate electrical energy, and
an attachment mechanism, the attachment mechanism including a connection element and an attachment mechanism electrical contact that is configured to output the electrical energy generated by the one or more photovoltaic cells; and
a portable power bank configured to removably connect to the solar panel, the portable power bank comprising:
a portable power bank electrical contact configured to contact the attachment mechanism electrical contact and receive the electrical energy output by the attachment mechanism electrical contact when the portable power bank is connected to the solar panel, and
a connection member having an engagement position and a disengagement position, the connection member configured to engage the connection element of the attachment mechanism when in the engagement position and disengage the connection element of the attachment mechanism when in the disengagement position, wherein when the connection member engages the connection element the portable power bank is secured in place at the solar panel and when the connection member disengages the connection element the portable power bank is removable from the solar panel.

2. The apparatus of claim 1, wherein the portable power bank further comprises:
a first electrical outlet port configured to electrically connect the portable power bank to a first electrical load device and provide electrical power to the first electrical load device.

3. The apparatus of claim 2, wherein the portable power bank further comprises:
a second electrical outlet port configured to electrically connect the portable power bank to a second electrical load device and provide electrical power to the second electrical load device, wherein the first electrical outlet port and the second electrical outlet port are adapted to electrically connect to different types of electrical connectors of the respective first electrical load device and the second electrical load device.

4. The apparatus of claim 1, wherein the portable power bank further comprises:
an attachment receptacle configured to receive the attachment mechanism, wherein the portable power bank electrical contact and the connection member are located at the attachment receptacle.

5. The apparatus of claim 4,
wherein the attachment mechanism further comprises a second connection element spaced apart along the attachment mechanism from the connection element, and
wherein the portable power bank further comprises a second connection member located at the attachment receptacle and having an engagement position and a disengagement position, the second connection member configured to engage the second connection element of the attachment mechanism when in the engagement position and disengage the second connection element of the attachment mechanism when in the disengagement position, wherein when the connection member and the second connection member engage the respective connection element and second connection element the portable power bank is secured in place at the solar panel and when the connection member and the second connection member disengage the respective connection element and second connection element the portable power bank is removable from the solar panel.

6. The apparatus of claim 5, wherein the connection element and the second connection element are located on a same side of the attachment mechanism, wherein the connection member and the second connection member are located on a same side of the attachment receptacle.

7. The apparatus of claim 6,
wherein the attachment mechanism further comprises an orientation groove, and
wherein the portable power bank further comprises an orientation fitment structure located at the attachment receptacle, and wherein the orientation groove is configured to receive the orientation fitment structure when the attachment receptacle receives the attachment mechanism.

8. The apparatus of claim 7, wherein the orientation groove is located on the side of the attachment mechanism having the connection element and the second connection element, wherein the orientation fitment structure is located on the side of the attachment receptacle having the connection member and the second connection member, and wherein the attachment receptacle is unable to receive the attachment mechanism when the portable power bank is oriented relative to the attachment mechanism such that the side of the attachment mechanism having the connection element and the second connection element does not interface with the side of the attachment receptacle having the connection member and the second connection member.

9. The apparatus of claim 1,
wherein the attachment mechanism further comprises a second attachment mechanism electrical contact that is configured to output the electrical energy generated by the one or more photovoltaic cells, the second attachment mechanism electrical contact being spaced apart along the attachment mechanism from the attachment mechanism electrical contact, and
wherein the portable power bank further comprises a second portable power bank electrical contact configured to contact the second attachment mechanism electrical contact and receive the electrical energy output by the second attachment mechanism electrical contact when the portable power bank is connected to the solar panel, the second portable power bank electrical contact being spaced apart along the portable power bank from the portable power bank electrical contact.

10. The apparatus of claim 9,
wherein the attachment mechanism electrical contact and the second attachment mechanism electrical contact each extend from one side of the attachment mechanism to another opposite side of the attachment mechanism,
wherein the portable power bank further comprises an attachment receptacle configured to receive the attachment mechanism, wherein the portable power bank electrical contact and the second portable power bank electrical contact are each located at the attachment receptacle, and
wherein the portable power bank electrical contact extends from one side of the attachment receptacle to another opposite side of the attachment receptacle so as to contact the attachment mechanism electrical contact on both sides of the attachment mechanism when the attachment mechanism is received at the attachment receptacle, and wherein the second portable power bank electrical contact extends from one side of the attachment receptacle to another opposite side of the attachment receptacle so as to contact the second attachment mechanism electrical contact on both sides of the attachment mechanism when the attachment mechanism is received at the attachment receptacle.

11. The apparatus of claim 1,
wherein the attachment mechanism further comprises a guide channel, and
wherein the portable power bank further comprises a channel fitment structure configured to be received at the guide channel when the portable power bank is secured in place at the solar panel.

12. The apparatus of claim 11,
wherein the guide channel extends from one side of the attachment mechanism to another opposite side of the attachment mechanism,
wherein the portable power bank further comprises an attachment receptacle configured to receive the attachment mechanism, wherein the channel fitment structure is located at the attachment receptacle, and
wherein the channel fitment structure extends from one side of the attachment receptacle to another opposite side of the attachment receptacle so as to contact the guide channel on both sides of the attachment mechanism when the attachment mechanism is received at the attachment receptacle.

13. The apparatus of claim 12,
wherein the guide channel forms a recess in the attachment mechanism of a varying recess depth, and
wherein the channel fitment structure includes an interior surface that is angled to match the varying recess depth formed by the guide channel.

14. The apparatus of claim 1, wherein the connection member further includes a biasing member that biases the connection member to the engagement position.

15. The apparatus of claim 14,
wherein the portable power bank further comprises an attachment receptacle configured to receive the attachment mechanism, and
wherein the connection member further comprises an extension face that extends into the attachment receptacle in the engagement position and is retracted within a wall of the attachment receptacle in the disengagement position, and wherein the extension face engages the connection element of the attachment mechanism in the engagement position.

16. A portable power bank comprising:
an attachment receptacle configured to receive an attachment mechanism;
a portable power bank electrical contact configured to contact an attachment mechanism electrical contact to establish an electrical connection between the portable power bank and the attachment mechanism; and
a connection member located at the attachment receptacle and having an engagement position and a disengagement position, the connection member configured to engage a connection element of the attachment mechanism when in the engagement position and disengage the connection element of the attachment mechanism when in the disengagement position, wherein when the connection member engages the connection element the portable power bank is secured in place at the attachment mechanism and when the connection member disengages the connection element the portable power bank is removable from the attachment mechanism.

17. The portable power bank of claim 16, further comprising:
a second connection member located at the attachment receptacle and having an engagement position and a disengagement position, the second connection member configured to engage a second connection element of the attachment mechanism when in the engagement position and disengage the second connection element of the attachment mechanism when in the disengagement position, wherein when the connection member and the second connection member engage the respective connection element and second connection element the portable power bank is secured in place at the attachment mechanism and when the connection member and the second connection member disengage the respective connection element and second connection element the portable power bank is removable from the attachment mechanism.

18. The portable power bank of claim 16, further comprising:
a second portable power bank electrical contact configured to contact a second attachment mechanism electrical contact to establish an electrical connection between the portable power bank and the attachment mechanism, the second portable power bank electrical contact being spaced apart along the attachment receptacle from the portable power bank electrical contact.

19. The portable power bank of claim 16, further comprising:
an orientation fitment structure located at the attachment receptacle, wherein the orientation fitment structure is configured to be received at an orientation groove on the attachment mechanism when the attachment receptacle receives the attachment mechanism.

20. The portable power bank of claim 16, further comprising:
a channel fitment structure located at the attachment receptacle, wherein the channel fitment structure is configured to be received at a guide channel on the attachment mechanism when the attachment receptacle receives the attachment mechanism.
